(19) United States
(12) Patent Application Publication
(10) Pub. No.: US 2025/0092945 A1
(43) Pub. Date: Mar. 20, 2025

(54) METHOD FOR MANUFACTURING HIGH-TEMPERATURE STRUCTURAL MATERIAL AND PRECURSOR

(71) Applicant: City University of Hong Kong Matter Science Research Institute (Futian), Shenzhen (CN)

(72) Inventors: Jian LU, Shenzhen (CN); Guo LIU, Shenzhen (CN); Jianan YIN, Shenzhen (CN); Xiaofeng ZHANG, Shenzhen (CN); Xinya LU, Shenzhen (CN)

(73) Assignee: City University of Hong Kong Matter Science Research Institute (Futian), Shenzhen (CN)

(21) Appl. No.: 18/963,748

(22) Filed: Nov. 28, 2024

Related U.S. Application Data
(62) Division of application No. 17/683,511, filed on Mar. 1, 2022.
Application No. 17/683,511 is a continuation of application No. PCT/CN2021/130371, filed on Nov. 12, 2021.

(30) Foreign Application Priority Data
Nov. 3, 2021 (CN) 202111294182.4

(51) Int. Cl. F16H 55/06; B28B 1/00; B33Y 10/00; B33Y 40/10; B33Y 70/10; C08J 3/28

(52) U.S. Cl. CPC F16H 55/06; B28B 1/002; B33Y 10/00; B33Y 40/10; B33Y 70/10; C08J 3/28; C08J 2300/00

(57) ABSTRACT

A precursor is made of a polymer or the polymer and a high-temperature material. The polymer includes at least one of silicone material, cellulose, hydrogel, and acrylic acid ammonium salt polymer. The silicone material is silicone rubber, and the high-temperature material includes one of ceramics, glass, metal, diamond, and high-temperature composite material.

### CROSS-REFERENCE TO RELATED APPLICATIONS

This application is a divisional of U.S. patent application Ser. No. 17/683,511, filed on Mar. 1, 2022, which is a continuation application of International Application No. PCT/CN2021/130371, filed on Nov. 12, 2021, which claims priority to Chinese Patent Application Ser. No. 202111294182.4, filed on Nov. 3, 2021. All of the aforementioned applications are incorporated herein by reference in their entireties.

### TECHNICAL FIELD

The present disclosure relates to the technical field of high-temperature material processing, and in particular to a method for manufacturing a high-temperature structural material and a precursor.

### BACKGROUND

High-temperature structural materials, such as ceramics, glass, metals, and diamond materials, are usually difficult or even impossible to manufacture structures with complex shapes and high precision through conventional machining methods due to their inherent characteristics, such as high hardness and high melting point. For brittle materials, such as ceramics and glass, traditional machining will cause cracks or even breakage. Therefore, the conventional processing technology of high-temperature structural materials usually has the problems of high cost, low precision and high pollution.

### SUMMARY

The main objective of the present disclosure is to provide a method for manufacturing a high-temperature structural material and a precursor, which aims to solve the problem that it is difficult to manufacture the high-temperature structural material with a complex shape and a high-precision structure by the conventional machining method.

In order to achieve the above objective, the present disclosure provides a method for manufacturing a high-temperature structural material, including following operations:
providing a precursor, the precursor is made of a polymer or the polymer and a high-temperature material;
processing the precursor into a precursor object with a preset shape; and
converting the processed precursor object into a high-temperature material object through a preset processing method.

In an embodiment, the polymer includes at least one of silicone material, cellulose, hydrogel, and acrylic acid ammonium salt polymer, and the high-temperature material includes one of ceramics, glass, metal, diamond, and high-temperature composite material.

In an embodiment, the operation of processing the precursor into a precursor object with a preset shape includes:
processing the precursor into the precursor object with the preset shape through a high-energy beam.

In an embodiment, the high-energy beam includes at least one of a laser, a high-pressure water beam, an electron beam, and an ion beam.

In an embodiment, the operation of processing the precursor into the precursor object with the preset shape through a high-energy beam includes:
engraving and/or cutting through the high-energy beam to process the precursor into the precursor object with the preset shape.

In an embodiment, before the operation of providing a precursor, the method includes:
converting the precursor in a preset form into a solid precursor through an additive manufacturing technology.

In an embodiment, the preset form includes at least one of liquid, solid powder, and solid wire.

In an embodiment, the operation of converting the precursor in a preset form into a solid precursor through an additive manufacturing technology includes:
converting a liquid precursor into the solid precursor through the additive manufacturing technology.

In an embodiment, the operation of converting the precursor in a preset form into a solid precursor through an additive manufacturing technology includes:
converting the precursor in the preset form into the solid precursor through at least one of direct ink writing technology, film scraping technology, material extrusion technology, material jetting technology, photopolymerization technology, powder bed fusion technology.

In an embodiment, the operation of converting the processed precursor object into a high-temperature material object through a preset processing method includes:
converting the processed precursor object into the high-temperature material object through at least one of heat treatment, mechanical treatment and chemical treatment.

In an embodiment, the operation of converting the processed precursor object into the high-temperature material object through at least one of heat treatment, mechanical treatment and chemical treatment includes:
heat-treating the precursor object in a vacuum or in an inert atmosphere or in an oxidizing atmosphere or in a reducing atmosphere.

In an embodiment, a form of the high-temperature material is at least one of powder, fiber, whisker, and sheet.

In an embodiment, the method is applied to preparing an electronic device back plate, cultural relic research and restoration, and preparing a high-temperature microelectromechanical system.

The present disclosure further provides a precursor, and the precursor is made of a polymer or the polymer and a high-temperature material.

In an embodiment, the polymer includes at least one of silicone material, cellulose, hydrogel, and acrylic acid ammonium salt polymer.

In an embodiment, the high-temperature material includes one of ceramics, glass, metal, diamond, and high-temperature composite material.

In technical solutions of the present disclosure, the present disclosure provides a precursor, and the precursor is made of a polymer or the polymer and a high-temperature material. Due to the characteristics of the polymer, the precursor can be processed into a precursor object with a preset shape. Then the processed precursor object is converted into a high-temperature material object through a preset processing method. Thus, it is possible to overcome the difficult problem that the high-temperature material is difficult to process, and to manufacture the high-temperature material object with various required shapes. Through this method, the high-temperature material can be processed with complicated shapes while retaining the characteristics of the high-temperature material, the production method is ingenious, and the practicability is high.

### BRIEF DESCRIPTION OF THE DRAWINGS

In order to more clearly illustrate the embodiments of the present disclosure, drawings used in the embodiments will be briefly described below. Obviously, the drawings in the following description are only some embodiments of the present disclosure. It will be apparent to those skilled in the art that other figures can be obtained according to the structures shown in the drawings without creative work.

FIG. 1 is a schematic flowchart of a method for manufacturing a high-temperature structural material according to an embodiment of the present disclosure.

FIG. 2 is a schematic flowchart of a method for manufacturing a high-temperature structural material according to another embodiment of the present disclosure.

FIG. 3 is a schematic flowchart of a method for manufacturing a high-temperature structural material according to yet another embodiment of the present disclosure.

FIG. 4 is a schematic flowchart of a method for manufacturing a high-temperature structural material according to still another embodiment of the present disclosure.

The realization of the objective, functional characteristics, and advantages of the present disclosure are further described with reference to the accompanying drawings.

### DETAILED DESCRIPTION OF THE EMBODIMENTS

The technical solutions of the embodiments of the present disclosure will be described in more detail below with reference to the accompanying drawings. It is obvious that the embodiments to be described are only some rather than all of the embodiments of the present disclosure. All other embodiments obtained by persons skilled in the art based on the embodiments of the present disclosure without creative efforts shall fall within the scope of the present disclosure.

It should be noted that if there is a directional indication (such as up, down, left, right, front, rear . . . ) in the embodiments of the present disclosure, the directional indication is only used to explain the relative positional relationship, movement, etc. of the components in a certain posture (as shown in the drawings). If the specific posture changes, the directional indication will change accordingly.

In addition, the descriptions associated with, e.g., “first” and “second,” in the present disclosure are merely for descriptive purposes, and cannot be understood as indicating or suggesting relative importance or impliedly indicating the number of the indicated technical feature. Therefore, the feature associated with “first” or “second” can expressly or impliedly include at least one such feature. Besides, the meaning of “and/or” appearing in the disclosure includes three parallel scenarios. For example, “A and/or B” includes only A, or only B, or both A and B. The technical solutions between the various embodiments can be combined with each other, but they must be based on the realization of those of ordinary skill in the art. When the combination of technical solutions is contradictory or cannot be achieved, it should be considered that such a combination of technical solutions does not exist, nor is it within the scope of the present disclosure.

High-temperature structural materials, such as ceramics, glass, metals, and diamond materials, are usually difficult or even impossible to manufacture structures with complex shapes and high precision through conventional machining methods due to their inherent characteristics, such as high hardness and high melting point. For brittle materials, such as ceramics and glass, traditional machining will cause cracks or even breakage. Therefore, the conventional processing technology of high-temperature structural materials usually has the problems of high cost, low precision and high pollution.

The present disclosure provides a precursor, and the precursor is made of a polymer or the polymer and a high-temperature material. Due to the characteristics of the polymer, the precursor can be processed into a precursor object with a preset shape. Then the processed precursor object is converted into a high-temperature material object through a preset processing method. Thus, it is possible to overcome the difficult problem that the high-temperature material is difficult to process, and to manufacture the high-temperature material object with various required shapes. That is, the precursor can be used for the production of high-temperature structural material, which improves the production efficiency of the high-temperature structural material and reduces cost consumption.

Specifically, the polymer includes at least one of silicone material, cellulose, hydrogel, and acrylic acid ammonium salt polymer. In this embodiment, when the silicone material is contained in the polymer in the precursor, the precursor is processed into the precursor object with a preset shape, and then the precursor material is converted into glass or ceramic through a preset processing method. The present disclosure does not limit the type of the silicone. In this embodiment, the organic silicon material is silicone rubber. Similarly, the cellulose, the hydrogel, and the acrylic acid ammonium salt polymer correspond to different types of the high-temperature materials to manufacture different types of high-temperature structural materials. The manufacturing process is simple and the cost is low.

The present disclosure does not limit the type of the high-temperature material, and the high-temperature material includes one of ceramic, glass, metal, and diamond. In the traditional manufacturing process, since the ceramic and the glass are relatively brittle, cracks or even breakage are prone to occur during the traditional machining process. For diamonds and high-temperature metals due to their inherent characteristics, high hardness and high melting point, it is difficult to prepare structures with complex shapes and high precision. In this embodiment, the ceramic can be manufactured by the precursor containing the silicone or the cellulose or the hydrogel and ceramic particle additives to form an amorphous-crystalline dual-phase ceramic material or a crystalline ceramic material. The glass can be manufactured directly from the precursor containing the silicone material. By adding the metal and the diamond to the cellulose or the hydrogel, and the acrylic acid ammonium salt polymer, respectively, the required precursor is formed, then the required precursor is processed into a preset shape to form the precursor object, and then the precursor object is converted into the high-temperature structural material through a preset processing method. During the process of transforming from the precursor object into the high-temperature structural material, the material is converted into the metal and the diamond from the cellulose or the hydrogel and the metal, the acrylic acid ammonium salt polymer and the diamond. In this way, through the intermediate conversion method, the high-temperature material can be processed with complex shapes while still retaining the characteristics of the high-temperature material, the production method is ingenious, and the practicability is high.

In order to facilitate the mixing of the polymer and the high-temperature material, and to facilitate the formation of the high-temperature structural material, the present disclosure does not limit the form of the high-temperature material, which can be at least one of powder, fiber, whisker, and sheet. That is to say, during the actual production process, the form of the high-temperature material can be one of powder, fiber, whisker, and sheet, or a combination of powder, fiber, whisker, and sheet. In this embodiment, the structures of the ceramic, the glass, the metal, and the diamond are respectively set as the powder of the ceramic, the powder of the glass, the powder of the metal, and the powder of the diamond. It should be noted that since the silicone material can be converted into the glass through a preset treatment, in addition, when it needs to be mixed with other polymers, the powder that can be added to the glass is transformed into the glass through a preset processing method in the subsequent steps, such an arrangement improves the flexibility of the manufacturing process and can speed up the mixing of the polymer and the corresponding high-temperature material.

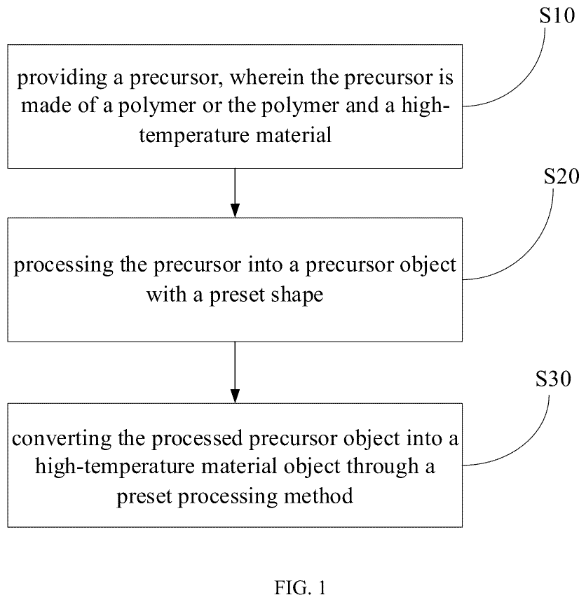

The present disclosure further provides a method for manufacturing a high-temperature structural material. As shown in FIG. 1, the method includes following operations.

Operation S10, providing a precursor, the precursor is made of a polymer or the polymer and a high-temperature material;

Operation S20, processing the precursor into a precursor object with a preset shape; and

Operation S30, converting the processed precursor object into a high-temperature material object through a preset processing method.

In technical solutions of the present disclosure, the present disclosure provides a precursor, and the precursor is made of a polymer or the polymer and a high-temperature material. Due to the characteristics of the polymer, the precursor can be processed into a precursor object with a preset shape. Then the processed precursor object is converted into a high-temperature material object through a preset processing method. Thus, it is possible to overcome the difficult problem that the high-temperature material is difficult to process, and to manufacture the high-temperature material object with various required shapes. Through this method, the high-temperature material can be processed with complicated shapes while retaining the characteristics of the high-temperature material, the production method is ingenious, and the practicability is high.

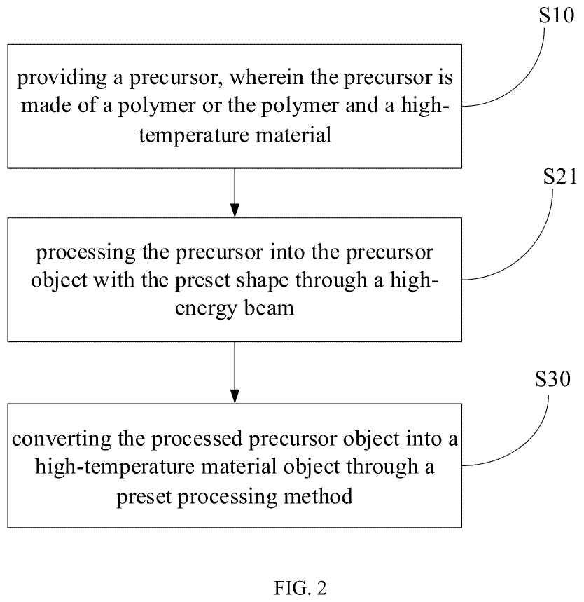

As shown in FIG. 2, in order to process the precursor into a precursor object with a predetermined shape, the operation S20 includes:

Operation S21, processing the precursor into the precursor object with the preset shape through a high-energy beam.

It should be noted that the high-energy beam includes at least one of a laser, a high-pressure water beam, an electron beam, and an ion beam, which is not limited herein.

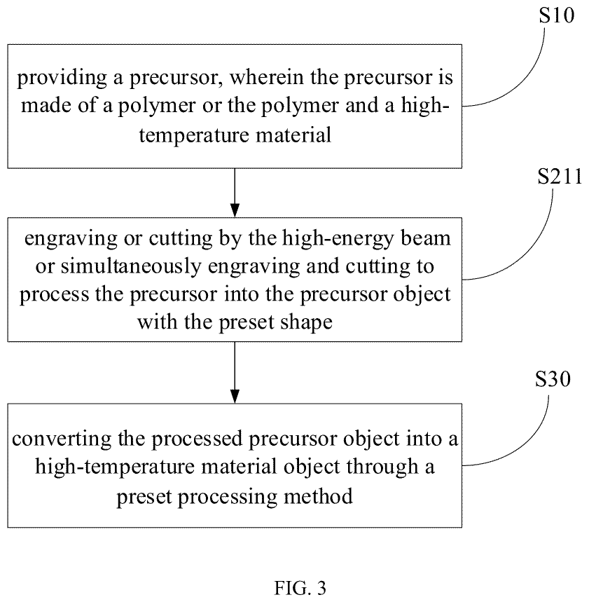

As shown in FIG. 3, the operation S21 includes:

Operation S211, engraving or cutting by the high-energy beam or simultaneously engraving and cutting to process the precursor into the precursor object with the preset shape.

In this embodiment, the processing method includes a laser engraving method, a laser cutting method, a water cutting method, and a water engraving method. Since the laser, the electron beam and the ion beam are all processing methods with higher energy, and are controlled by a controller, easy to operate and have high precision, they are generally applied to the processing technology of engraving and cutting. Compared with the laser, the electron beam and the ion beam, the high-pressure water beam is less convenient to operate and more difficult to control with precision, which is generally applied to cutting processes.

The roundness of the hole of the high-temperature material with a diameter of 0.85 mm obtained by the laser processing is less than 0.082.

The roundness of the hole of the high-temperature material with a diameter of 0.85 mm obtained by the high-pressure water beam processing is less than 0.018.

The roundness of the hole of the high-temperature structural material with a diameter of 0.85 mm obtained by the laser processing can be less than 0.082, and the roundness of the hole of the high-temperature structural material with a diameter of 0.85 mm obtained by the high-pressure water beam processing can be as small as 0.018 or less.

For example, the laser engraving method can be used to fabricate the precursor whose corresponding high-temperature material is the ceramic into a single ceramic gear with diameters of 5.6 mm, 2.8 mm, 1.4 mm, and 0.7 mm, respectively or a ceramic planetary gear system. For the macro-ceramic gear system prepared by laser engraving the precursor, the outer tooth diameter can reach 700 μm. Besides, since the accuracy of the water cutting method is higher than that of the laser engraving method, and the precursor of the glass material with high-resolution holes can be processed by the water cutting method, similarly, the water cutting method can process the precursor of the ceramic material to generate a high-resolution ceramic planetary gear system with meshing transmission. In this way, by combining the precursor with at least one of the laser engraving method, the laser cutting method, the water cutting method, and the water engraving method, it can process high-temperature materials that cannot be processed by traditional processing methods, and the processing method is simple, the processing efficiency is high, and the processing accuracy is high.

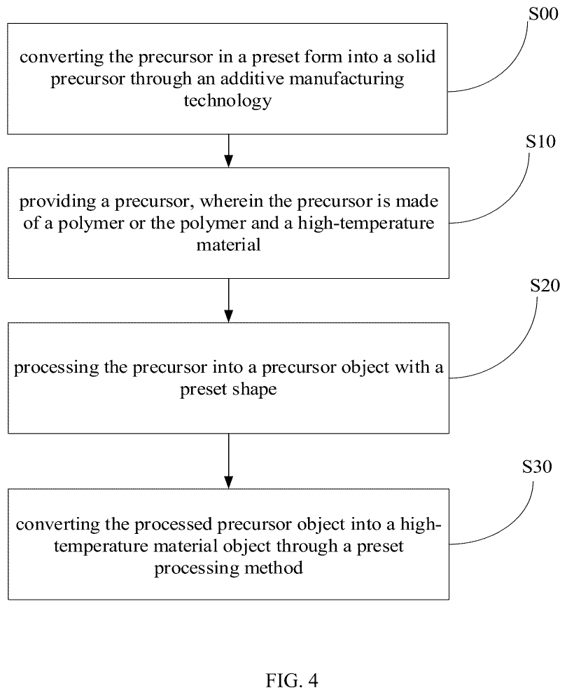

As shown in FIG. 4, in order to make a more complicated shape of the precursor, before the operation S10, the method further includes the following operations:

Operation S00, converting the precursor in a preset form into a solid precursor through an additive manufacturing technology.

The additive manufacturing technology refers to a scientific and technological system that directly manufactures parts based on the principle of discrete-stacking, driven by part three-dimensional data, for example, 3D printing technology or 4D printing technology. That is, the precursor in a preset form can be converted into the solid precursor in a preset shape through the additive manufacturing technology. The present disclosure does not limit the setting form, and the setting form includes at least one of liquid, solid powder and solid wire, which is specifically set by the operator according to different needs.

Specifically, the method further includes:

converting a liquid precursor into the solid precursor through the additive manufacturing technology.

Besides, the operation S00 further includes:
converting the precursor in the preset form into the solid precursor through at least one of direct ink writing technology, film scraping technology, material extrusion technology, material jetting technology, photopolymerization technology, powder bed fusion technology.

Specifically, the direct ink writing technology is extruding the precursor in the form of ink by means of air pressure or a screw, and controlling the displacement of the nozzle through a program, and stacking the precursor into a 3D structure layer by layer, and then solidifying the precursor into a solid. The film scraping technology is shaping the precursor in the ink state into a thin film structure on the substrate by a squeegee, and then solidifying the precursor into a solid, which is also an additive manufacturing method. The material extrusion technology is that the precursor in the solid wire state is continuously formed into a certain shape through a nozzle of a certain shape under the action of heating, melting and extrusion, and then solidified into the solid precursor. The operation is simple, the process is easy to operate, can be automated production, and the production efficiency is high. The material jetting technology is one of the 3D printing technologies, an inkjet head is used to deposit the liquid droplets of the precursor to the desired position, and an inkjet head generally has tens to hundreds of nozzles for material deposition. The photopolymerization technology is a process in which a liquid substance with chemical reaction activity is rapidly transformed into a solid substance by using ultraviolet light or visible light. Thereby, the liquid precursor can be converted into the solid precursor, and the photopolymerization technology is energy-saving and environmentally friendly, no solvent volatilization, high production efficiency, wide adaptability, and low cost. The powder bed fusion technology is an additive manufacturing technology with flexible design and high effective utilization of resources. Specifically, a thin layer of powder material is laid on the substrate, and the entire powder layer is irradiated by electron beams or lasers to heat the powder layer, then the power material is laid on the substrate layer by layer, and the electron beam or the laser is used to irradiate the entire powder layer to heat the powder layer, so that layer by layer is piled up to form the precursor with the preset shape. In this embodiment, the direct ink writing technology or the film scraping technology is used.

It should be noted that when actually manufacturing the high-temperature structural material, one of the direct ink writing technology, the film scraping technology, the material extrusion technology, the material jetting technology, the photopolymerization technology, and the powder bed fusion technology can be selected to convert the precursor with the preset form into the solid precursor. It is also possible to select two, three, four, five technologies to combine, or even six technologies to combine to convert the precursor in the preset state into the solid precursor according to actual needs. The details need to be changed according to the actual needs of the operators, which is not limited herein.

Specifically, the operation S30 includes:
converting the processed precursor object into the high-temperature material object through at least one of heat treatment, mechanical treatment and chemical treatment.

The present disclosure does not limit the method of converting the precursor object into a high-temperature material object, which specifically includes heat treatment, mechanical treatment, and chemical treatment. One of the methods can be selected for processing, two processing methods can also be selected for combination, and three processing methods can also be used for combination, and the specific needs to be changed according to the actual needs of the operator, which is not limited here.

More specifically, the operation S30 includes:
heat-treating the precursor object in a vacuum or in an inert atmosphere or in an oxidizing atmosphere or in a reducing atmosphere.

According to the different high-temperature materials in the high-temperature material objects to be manufactured, different processing environments can be used. The processing environment includes vacuum, inert atmosphere, oxidizing atmosphere and reducing atmosphere. In actual production, the operator can select a suitable processing environment according to the difference of the high-temperature material in the high-temperature material object, which is not limited herein.

In the actual application process, the additive manufacturing technology, the laser engraving method, and the laser cutting method can be used to process the precursor in which the high-temperature material is ceramic. In the application field of mobile phones, the ceramic material has excellent electromagnetic signal transmission ability, and the glossy appearance and fine texture of a well-polished ceramic structure, can provide an excellent visual and tactile experience, and the precursor can be processed by the laser cutting method or the laser engraving method. Therefore, the processing of the camera hole and the engraving of the internal surface texture of the mobile phone back plate can be realized at a lower cost. Using this method, the cost is low, and the environmental performance is good.

The laser engraving method can also be used to produce ceramic MEMS (microelectromechanical system) resonant strain sensors. In this embodiment, the sensor has a length of up to 12 cm, has 2812 pairs of electrodes, and the width and gap of the tuning fork are about 80 μm, which simultaneously achieves large size and high precision. Due to the characteristics of the ceramic, the ceramic MEMS resonant strain sensor can resist high temperature, temperature gradient, humidity and other environmental influences, and the scalability of the ceramic MEMS strain resonant sensor is made to improve the strain sensitivity.

In addition, the manufacturing method of the high-temperature structural material can also be applied to the research and restoration of cultural relics. Since most of the cultural relics have complex structures, the method for manufacturing the high-temperature structural material can be used to process some glass or ceramic restoration parts to restore the cultural relics. Alternatively, paintings or calligraphy can be produced by the method of manufacturing the high-temperature structural material one-to-one or according to a certain ratio for research and restoration by researchers, which can provide greater research value while protecting cultural relics.

In this embodiment, the laser cutting method is used to process a hole on the ceramic precursor object, and the diameter of the ceramic precursor hole is within 0.21 mm to 0.31 mm, specifically 0.26 mm. The precursor object is heat-treated, and after the heat-treatment, the precursor object is converted into the high-temperature structural material, so that the size of the ceramic precursor hole shrinks, and the diameter of the ceramic precursor hole is within 0.15 mm to 0.25 mm, specifically 0.2 mm.

In addition, the laser cutting method is used to process a hole with a diameter of 1 mm on the ceramic precursor object, and the roundness of the ceramic precursor hole is 0.102. After the heat treatment, the diameter of the ceramic precursor pores of the high-temperature structural material is within 0.8 mm to 0.9 mm, specifically 0.85 mm, and the roundness is 0.082. In this way, the heat treatment is combined with the laser cutting method to improve the processing accuracy.

In an embodiment, the laser engraving method is used to prepare the precursor object of the high-temperature material with the ceramic to prepare a macro-ceramic gear system. Due to the characteristics of the precursor of the high-temperature material of the ceramic, and the laser engraving method has higher precision and good operating performance, such that the diameter of the outer teeth can be as small as 700 μm. The precursor object can be heat-treated, and according to different heat treatment time, it can be transformed into amorphous-crystalline dual-phase ceramics or amorphous glass.

The above are only some embodiments of the present disclosure, and do not limit the scope of the present disclosure thereto. Under the inventive concept of the present disclosure, equivalent structural transformations made according to the description and drawings of the present disclosure, or direct/indirect application in other related technical fields are included in the scope of the present disclosure.

What is claimed is:

1. A precursor, wherein the precursor is made of a polymer or the polymer and a high-temperature material.

2. The precursor of claim 1, wherein the polymer comprises at least one of silicone material, cellulose, hydrogel, and acrylic acid ammonium salt polymer.

3. The precursor of claim 2, wherein the silicone material is silicone rubber.

4. The precursor of claim 1, wherein the high-temperature material comprises one of ceramics, glass, metal, diamond, and high-temperature composite material.

5. The precursor of claim 1, wherein a form of the high-temperature material is at least one of powder, fiber, whisker, and sheet.

6. The precursor of claim 1, wherein the precursor in a preset form is converted into a solid precursor in a preset shape through an additive manufacturing technology.

7. The precursor of claim 6, wherein the preset form comprises at least one of liquid, solid powder, and solid wire.

8. The precursor of claim 1, wherein the precursor is processed into a precursor object with a preset shape by engraving and/or cutting through a high-energy beam.

9. The precursor of claim 8, wherein the high-energy beam comprises at least one of a laser, a high-pressure water beam, an electron beam, and an ion beam.

10. The precursor of claim 1, wherein the precursor object is converted into a high-temperature material object through at least one of heat treatment, mechanical treatment, and chemical treatment.
